(19) United States
(12) Patent Application Publication
(10) Pub. No.: US 2026/0192487 A1
(43) Pub. Date: Jul. 9, 2026

(54) METHOD OF MANUFACTURING A PARTICLE BOARD AND PARTICLE BOARD

(71) Applicant: SWISS KRONO Tec AG, Luzern (CH)

(72) Inventors: Joachim Hasch, Berlin (DE); Roger Braun, WILLISAU LU (CH); Norbert Kalwa, Horn – Bad Meinberg (DE)

(73) Assignee: SWISS KRONO Tec AG, Luzern (CH)

(21) Appl. No.: 19/127,796

(22) PCT Filed: Nov. 2, 2023
(86) PCT No.: PCT/EP2023/080554

§ 371 Date: May 7, 2025

(30) Foreign Application Priority Data
Nov. 7, 2022 (EP) 22205767.1

(51) Int. Cl. B27N 7/00

(52) U.S. Cl. CPC B27N 7/005

(57) ABSTRACT

The invention relates to a method for coating a waterproof particle board (1) in order to make the particle board better and more versatile in use, wherein the particle board has chips of wood with a length of 0.5 mm to 50 mm, with a width of 0.1 mm to 20 mm and with a thickness of 0.05 mm to 2 mm and at least one adhesive with an adhesive content of at least 12% by weight/atro wood, comprising the steps of:
providing the particle board (1), which has an upper face (1a) and a lower face (1b) and lateral surfaces,
applying a coating (3),
application of a decoration,
optionally structuring the coating (3), in each case on at least a section
an upper face, a lower face or a lateral surface, and
optionally curing the coating.

The invention also relates to a coated, waterproof particle board.

### BACKGROUND OF THE INVENTION

The invention relates to a method for manufacturing a particle board and a particle board, in particular a waterproof particle board.

Particle boards with an adhesive content of at least 12% that are dimensionally stable in the presence of moisture are referred to as waterproof particle boards. Such particle boards have a relatively rough and aesthetically unappealing surface.

It is the task of the invention to make such a waterproof particle board better and more versatile.

### SUMMARY OF THE INVENTION

The task is solved by a method and a particle board as disclosed herein. Dependent claims and the disclosure also relate to advantageous further embodiments of the invention.

The particle board has an adhesive content of at least 12% by weight/atro wood. In relation to the proportion of wood or chips, an adhesive content of at least 15% by weight/atro wood, preferably at least 17% by weight/atro wood, particularly preferably at least 20% by weight/atro wood, most preferably at least 25% by weight/atro wood is preferably applied to the chip material. Provided that an upper limit of moisture content of the layer and/or layers of the chip mat is maintained after the application of adhesive, any desired adhesive content can be applied to the chips. Preferably, the upper limit of the moisture content is between 1 wt. %/glued wood to 20 wt. %/glued wood, preferably between 3 wt. %/glued wood to 18 wt. %/glued wood, particularly preferably between 5 wt. %/glued wood to 15 wt. %/glued wood.

The adhesive content is expressed in relation to the chip material, i.e. the proportion of adhesive is given in relation to the weight of the chips used. In the case of chips that can absorb moisture (e.g. wood chip material), the adhesive content is based on wood that has dried to constant weight. The chip material is dried to constant weight at 103±2° C. and referred to as absolutely dry wood (atro wood: absolutely dry wood). The proportion of adhesive is given as 100% solids, i.e. without any added liquid.

Lignocellulosic material, for example wood, e.g. round wood, fresh wood, waste wood or residual wood or annual plants, typically straw or bagasse, is used to provide chips. The chip material has a length of 0.5 mm to 50 mm, a width of 0.1 to 20 mm and a thickness of 0.05 mm to 2 mm. A distinction is often made between coarse chip material with a length of 5 mm to 50 mm, a width of 1 to 20 mm and a thickness of 0.2 to 2 mm and fine chip material with a length of 0.5 mm to 25 mm, a width of 0.1 to 5 mm and a thickness of 0.05 to 1 mm.

The high adhesive content when applying adhesive to the chips allows the manufacturing of a water-resistant and therefore moisture-resistant particle board, which also has a high strength. Surprisingly, it has also been found that swelling of the particle board, e.g. due to 24 hours of water storage, is becoming reversible due to the high adhesive content. The determination of the swelling behavior is preferably carried out according to DIN EN 317. The particle board regains its initial dimensions after 24 hours of re-drying, e.g. at room temperature, e.g. initial length, initial width and initial thickness before 24 hours of water storage. From this it can be concluded that the adhesive bonds remain essentially damage-free during exposure to water. This swelling/shrinkage behavior has not been observed in particle boards to date; instead, proportionate, irreversible residual swelling was common. The complete recovery of the deformation generated by swelling has opened up new areas of application for particle board.

Particularly preferred for manufacturing the particle board an adhesive is used which has a first, thermosetting component and a second, thermoplastic component. The adhesive is used in a proportion of at least 12 wt %/atro wood to 60 wt %/atro wood, preferably from 15 wt %/atro wood to 45 wt %/atro wood, particularly preferably from 18 wt %/atro wood to 35 wt %/atro wood, especially from 20 wt %/atro wood to 33 wt %/atro wood, advantageously from 24 wt %/atro wood to 31 wt %/atro wood.

According to an advantageous embodiment of the invention, a condensation resin, in particular aminoplasts, such as melamine formaldehyde resin, urea formaldehyde resin (UF resin), or benzoguanamine resin, as well as phenoplasts, such as phenol formaldehyde resin (PF resin), are used as thermosetting component, in each case individually or in a mixture. Aminoplasts are used in aqueous solution, e.g. as melamine resin, usually as melamine formaldehyde resin (MF resin), whereby the solids content of the aminoplast is preferably at least 45% by weight relative to the aqueous solution; advantageously, the solids content is over 50% by weight. The upper limit of the solids content is determined by the solubility and optionally processability of the aminoplast in the production process, e.g. in spray nozzles or high-pressure gluing processes.

Preferably, the adhesive has melamine resin, e.g. MF resin (melamine formaldehyde resin), as at least the first component. Melamine resin is preferred because it has low swelling and low hygroscopicity and is resistant to hydrolysis. Alternatives are phenolic resin, urea resin or mixtures or combinations of several of these thermosetting first components. Although urea resin is not resistant to water, it can surprisingly be used, especially in mixture with melamine resin and/or phenolic resin, for manufacturing the particle board according to the invention. In particular, melamine resin can be used either alone as the first component or in combination with one or more of the other thermosetting components. The proportion of the UF resin is preferably up to 50% by weight of the MF or PF resin, without impairing the water-resistance or -strength of the particle board.

In combination, in the context of the present invention, means that mixtures of first component resins can be used, wherein either the mixture of two or more first component resins is applied to the chip materials simultaneously. Or several different resins of the first component are used one after the other, for example because they cannot be used in a mixture or because separate application of different resins of the first component or individual resins of the first component of the adhesive has advantageous effects, for example on the subsequent product and/or application properties.

Preferably, technical diphenylmethane diisocyanate (PMDI) is applied to the chip material as the second, thermoplastic component of the adhesive. Alternatively or additionally, other substances such as methylene diphenyl isocyanate (MDI), also in emulsified form as eMDI, but also polyurethane can be used as the second component. The proportion of the second component is preferably more than 1% by weight, in particular 3% by weight or more, advantageously 5% by weight or more, in each case based on atro wood. This means that the proportion of the second component, e.g. PMDI, in the particle board according to the invention is significantly higher than in conventional particle boards. Advantageously, the second component of the adhesive, e.g. PMDI, is also used in a multi-layered structure of the board, in particular in the surface layers of the particle board according to the invention. Preferably, the second component is used in equal amounts in the core layer and in the surface layer. Here too, several substances that are suitable as second components can be applied to chip materials either in a mixture with one another at the same time or individually one after the other.

Preferably, at least one third component, for example polyol or polyether, can be added to the first and second components of the adhesive, in each case preferably as a solid. The third component can be added in a proportion of up to 15% by weight, preferably up to 10% by weight, particularly preferably in a proportion of 2 to 5% by weight relative to the total amount of adhesive.

According to an advantageous embodiment, the elastic properties of the particle board can be modified, in particular improved, by adding an elastomer or thermoplastic that is used as an elasticizing additive, e.g. by adding polyvinyl acetate (PVAc) or ethyl vinyl acetate (EVA). Acrylate, styrene acrylate or polyurethane (PU) are preferably used to elasticize the particle board according to the invention, in particular in the form of a liquid additive such as a dispersion or emulsion, because they are waterproof. Acrylate, styrene acrylate and PU with a glass transition temperature of TG less than 0° C. are preferred. However, mono or diethylene glycol are also suitable for elasticizing the particle board. The above-mentioned elasticizing additives can be used individually or in a mixture. The addition of elastomers or thermoplastics reduces the brittleness of the particle board and improves its elastic properties, e.g. the modulus of elasticity. The addition of elasticizing additives also improves the flatness of the particle board according to the invention. The elasticizing additive is calculated as a solid in proportion to the total amount of the particle board (atro) in an amount of 1 wt. % to 5 wt. %, advantageously 2 wt. % to 4 wt. %. The elasticizing additives are added, for example, to the adhesive, e.g. melamine resin, before application to the chip material and are applied to the chips together with the adhesive. Preferably, the elasticizing agent is applied to the chips before or, more preferably, after the adhesive.

As described above, a first and a second, optionally also more components are used in combination as an adhesive. It is preferred if the adhesive predominantly has a first component, in particular melamine resin. It is further preferred if the proportion of the first component in the total amount of the adhesive exceeds 15% by weight, in particular 20% by weight. The first component and the second component of the adhesive can be continuously adjusted within a wide range depending on the requirements of the particle board. This preferably applies to both the core layer and the other layers in the case of a multi-layered board structure. They are preferably applied to the chip material in a ratio of 2:1, preferably 3:1, particularly preferably 4:1 or 5:1 of first component to second component or in a ratio between these values. If the particle board according to the invention has surface layers, a higher proportion of the first component of the adhesive is preferably used compared to the core layer.

The chips or chip mat are particularly preferably pressed into a particle board with an odd number of layers, whereby the layers differ in particular by different chip sizes. For example, the particle board has three or five superimposed layers. In a particle board with three layers, for example, a core layer is arranged between two surface layers. The core layer typically consists of a proportion of at least 30% by weight, preferably at least 45% by weight, particularly preferably at least 60% by weight of a pressed particle board and usually has coarse chips. The surface layers are scattered symmetrically or asymmetrically in relation to their proportion by weight and usually have fine chips. If the particle board according to the invention consists of a single-layered structure, different chip fractions of coarse and fine chips are brought together in one layer.

One or more additives, e.g. antioxidants, light stabilizers, antistatic agents, colorants, fungicides, flame retardants, agents for adjusting the thermal or electrical conductivity, or one or more fillers can also be used for manufacturing the particle board according to the invention. Mineral particles, for example, but also ceramic, synthetic or glass or plastic particles can be used as fillers. A combination of additives or fillers can also be applied to the chip material, either individually or as a mixture. Fillers and/or additives can also be applied, in particular applied in a mixture with the adhesive.

According to an advantageous embodiment of the invention, a hydrophobizing agent is applied to the chip mats prior to pressing the chip material, in particular after applying the adhesive to the chips. The hydrophobizing agents provided are, for example, paraffin or wax, which are typically used in amounts of up to 5% by weight/atro wood, usually in amounts of up to 2% by weight/atro wood, often in an amount of 0.1% by weight/atro wood to 1% by weight/atro wood, optionally up to 1.5% by weight/atro wood. The use of hydrophobizing agents helps to reduce the tendency of the particle board to swell and to increase its moisture resistance.

According to an advantageous further development of the invention, the particle board is ground after pressing. For this purpose, a sanding device with an abrasive, e.g. an abrasive paper and/or preferably an abrasive belt, may be provided. Sanding is usually carried out in two sanding passes, with abrasives having a grain size of 50-60 being used in the first sanding pass and 80-100 in the second sanding pass. The particle board according to the invention has a harder surface compared to known particle board according to DIN EN 312, for which a coarser grain size of the abrasive is preferred. Preferably, the grain size in both sanding passes is a maximum of 60, preferably a maximum of 50, particularly preferably a maximum of 40.

The particle board produced by the method described above can be adapted to different requirements by different combinations of chips, adhesive, fillers and optionally other additives such as waxes. It is therefore expressly pointed out that the features described in connection with the present invention can be freely combined with one another.

The particle board according to the invention is preferably waterproof and thus also moisture-resistant. It has an excellent and unusual swelling and shrinkage behavior, in which an already low swelling is additionally accompanied by an extensive recovery of the swelling during subsequent drying.

The particle board according to the invention is typically board-shaped, i.e. it generally has two main surfaces, which are also referred to below as the upper and lower face. The upper and lower faces are spaced apart by the thickness of the particle board. The narrow faces of the particle board, which merge into the upper and lower faces at the edges, extend between the upper and lower faces. The thickness of the finished particle board can range from 2 mm to 80 mm, typically between 3 mm and 50 mm, usually between 3 mm and 32 mm. A typical application may require a particle board thickness of 6 mm to 32 mm. The particle board may have flat main surfaces; however, the upper and/or lower faces may also be embossed or milled or otherwise machined, resulting in a variable thickness of the particle board based on the area of the particle board.

The narrow faces of the particle board according to the invention can be machined using conventional tools. They can be sawn, cut or milled. The maximum length and width of the particle board can be cut to length as required, for example during the finishing process. Smaller dimensions can be manufactured, for example, by cutting up the particle board originally manufactured in the press. Typical dimensions of the particle board can be 6700 mm (length)×2500 mm (width) after manufacturing in the press, 1380 mm×195 mm, after dividing into floor, wall or ceiling panels or 3048 mm×2800 mm. The latter format is particularly suitable for use in construction because the width of the board corresponds to a standard storey height.

Advantageously, the particle board according to the invention has only a minimum thickness swelling, in particular according to the test method described in DIN EN 317, which is less than 5%, advantageously less than 4%, preferably less than 3%, particularly preferably less than 2.5%, in relation to the original board thickness. An uncoated particle board also advantageously has an edge swelling of less than 6%, preferably less than 5%, in accordance with the test method described in EN-13329, and a coated particle board particularly preferably has an edge swelling of less than 4%. The swelling can be reduced by more than 90% compared to a standard particle board of the same thickness made from the same chip material but with less adhesive and other types of adhesive. A value of less than 5% for the edge swelling of the uncoated particle board and less than 4% for the edge swelling of a coated particle board is therefore an exceptional improvement compared to known particle boards according to DIN EN 312.

The average density of the particle board according to the invention is preferably 800 kg/m³ to 1,000 kg/m³, preferably 830 kg/m³ to 970 kg/m³, particularly preferably 850 kg/m³ to 950 kg/m³. It is thus approx. 100 kg/m³ to 300 kg/m³ higher than in the case of known particle boards of type P2 according to DIN EN 312.

The particle board according to the invention has very good strength properties, in particular a high transverse tensile strength, which is at least 2.5 N/mm², preferably up to 3 N/mm², in particular up to 4 N/mm². Preferably, the particle board has a modulus of elasticity of 3000 N/mm² to 5000 N/mm², advantageously from 3500 to 5000 N/mm², particularly preferably from 4000 to 5000 N/mm². The good strength properties mean that fewer fasteners, e.g. screws, need to be used to fasten the particle board according to the invention because the individual fastener has a better hold in the board. The higher transverse tensile strength also allows more intensive processing of a particle board according to the invention, e.g. milling simple profiles into the side edge of a board. For example, at least one simple profile, such as a tongue and groove profile, can be machined into the narrow face of a particle board, which aligns two interlocking boards in both vertical and horizontal directions. A high flexural strength of the particle board of at least 35 N/mm², preferably at least 40 N/mm², allows it to be used as a structural element, e.g. wall bracing.

The invention further relates to the use of the particle board described above for structural purposes in indoor and outdoor areas. The particle board according to the invention is characterized by the fact that it can be used in a variety of ways due to the minimal swelling, in particular the reduced thickness swelling in the area of the narrow faces. In interior construction, the particle board can be used, for example, as a floorboard or as a floor covering, in each case with or without a coating. In contrast to non-waterproof floorboards or floor coverings, for example, it can also be used in damp and wet rooms, in particular because the narrow faces, which optionally have an edge profile where the board is freely accessible to moisture, no longer swell significantly under the influence of water or high moisture or return almost completely to their original dimensions when they dry.

This means, for example, that an essentially non-swelling, dimensionally stable particle board with high strength values that is resistant to water and humidity and is not limited to narrow formats can now be manufactured on known devices for manufacturing wood-based boards.

Of course, the particle board according to the invention can also be used as a wall or ceiling board, as a furniture board and as a construction board, in particular for finishing damp and wet rooms or laboratory and technical rooms or workshops, but is not limited to this. In outdoor construction, the particle board according to the invention is also suitable as a construction panel, typically e.g. as facade panel, for exterior window sills, coverings including roof coverings and wall elements.

The coated particle board according to the invention can be used, for example, for indoor and outdoor floors. In this way, it is possible to use the same flooring or floor coverings for indoor and adjacent outdoor areas (terraces, balconies, facades, access routes). Preferably, the particle board according to the invention can be used for constructions, in particular furniture, in indoor and outdoor areas. The finishing of workshops, production halls or stables, for example, can easily be carried out with the coated particle board according to the invention. Not only vertical, but above all horizontal surfaces can be manufactured, which have to be waterproof or moisture-resistant. Furthermore, due to its water resistance, the coated particle board according to the invention can also be used, for example, for fire protection elements and construction elements in shipbuilding, in particular if it is provided or coated with fire protection substances and thus designed to be flame-retardant, for example, not only in technical areas but also in areas used by passengers, since decorative surfaces can be designed.

The coated particle board can optionally be configured as a panel, i.e. provided with a profile on at least one, usually two or four edges if required. The profile is preferably used to fix two panels together, usually without the use of adhesives. Alternatively, two panels arranged next to each other can also be connected joint-to-joint. For example, they can be fixed in place using a double-sided adhesive tape arranged in the area to the side of a joint between the directly adjacent panels. It is also possible to glue directly adjacent panels or boards together, preferably using a waterproof adhesive.

The surface of uncoated particle board is rough and is not suitable for decorative or certain non-decorative applications, e.g. due to the roughness of the surface. The care and hygienic maintenance of a rough surface is hardly possible. There is no prior art information on the coatability of a waterproof particle board. Surprisingly, it has been found that the waterproof particle board can be coated in a variety of ways:

The waterproof particle board can be provided with a single or multi-layered coating applied at least in sections. The coating is applied to at least one section of the surface of the waterproof particle board, typically on one side and/or edge. Preferably, a coating is applied to the upper and/or lower face of the particle board.

The coating can have one or more layers, comprising for example synthetic resin, lacquer, paper, in particular paper impregnated with synthetic resin, veneer, film, in particular metal or plastic film, cork, felt and/or laminate. If paper, in particular paper impregnated with synthetic resin, is used, it can be an overlay without decor, a decor paper, an underlay or a backing paper, for example. These synthetic resin-impregnated papers are characterized by the fact that the synthetic resin with which they are impregnated has dried but is still chemically reactive, i.e. has not yet cured. A combination of at least one decorative paper and an overlay is preferred. Melamine formaldehyde resin and/or urea resin can typically be used as the synthetic resin. Alternatively, however, it can also be a laminate manufactured from a plurality of synthetic resin-impregnated papers that are pressed together, whereby the synthetic resin, typically melamine and/or urea, is cured, which is why the laminate is also listed separately in the coatings.

The coating may have several layers of the same material. However, it can also comprise several layers of two or more of the aforementioned materials. Typical combinations of layers include, for example, synthetic resin, paper and lacquer, laminate and lacquer, veneer and lacquer, paper or veneer and lacquer. The coating may be applied in solid or liquid form, e.g. in the case of synthetic resin or lacquer. The coating can be applied to the surface of the waterproof particle board to be coated, e.g. by spraying, pouring, rolling, squeegeeing or jetting. Flat coatings such as paper, laminate, film or veneer are applied to the surface of the waterproof particle board to be coated.

The coating can be designed with a decor. In addition or as an alternative to a decor, it can have a structure, i.e. a three-dimensionally designed surface. Preferably, the structure is adapted to the decor (embossed in register).

The coating can be fixed to the waterproof particle board by an adhesive. Hotmelt adhesives, also known as hotmelts, are often used as adhesives. Typical hot-melt adhesives include polyvinyl acetate (PVAc), polyamide resins, saturated polyesters, ethylene-vinyl acetate copolymers (EVA), polyolefins, block copolymers (e.g. styrene-butadiene-styrene or styrene-isoprene-styrene) and polyimides. Polyvinyl acetate, ethylene-vinyl acetate copolymers and polyolefins are particularly suitable for fixing a coating. The adhesives used for applying the coating or as a coating, e.g. hotmelts, are not identical to the adhesives used for manufacturing the waterproof particle board.

Alternatively, the coating can be applied directly to the waterproof particle board, especially if synthetic resins or lacquers are applied. The coating is preferably applied to the waterproof particle board by pressing, optionally at an elevated temperature. Alternatively, coatings can be cured by drying or heating, e.g. with infrared or ultraviolet radiation or with electron radiation. The particle board with the coating already applied but not yet fixed can be pressed directly or exposed to radiation. If a flat coating has been applied, it is advantageous to manufacture a stack of material to be pressed, in which the coating and the waterproof particle board are stacked on top of each other and then pressed, for example.

The coating can be supplemented by further layers, which are generally not arranged on the outer face. Such additional layers can be: a base coat, a primer, or one or more layers containing corundum, glass particles, plastic particles and/or metal particles.

### BRIEF DESCRIPTION OF THE DRAWINGS

In the following, exemplary embodiments of the invention are explained in more detail with reference to drawings. These show:

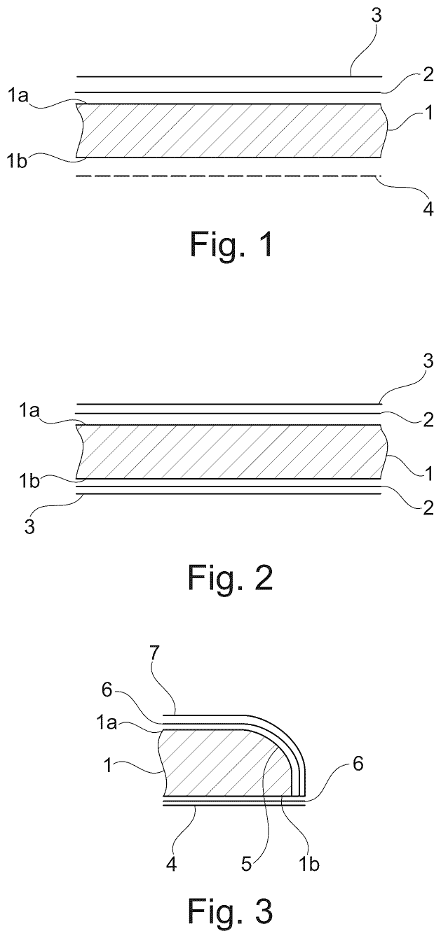

in FIG. 1 a schematic representation of the cross-section of a coated waterproof particle board with a coating of synthetic resin-impregnated paper on the upper face;

in FIG. 2 a schematic representation of the cross-section of a coated waterproof particle board with a coating of synthetic resin-impregnated paper on the upper face and the lower face;

in FIG. 3 a schematic representation of the cross-section of a coated waterproof particle board with a laminated coating of laminate

### DETAILED DESCRIPTION

For all of the following exemplary embodiments, a three-layer waterproof particle board with an adhesive content of more than 12% by weight is used, preferably with an adhesive content of 25% by weight in the two outer surface layers and 30% by weight in the core layer, which is located between the outer surface layers. In addition to a higher bulk density of approx. 880 kg/m³ compared to a normal particle board (approx. 720 kg/m³), this waterproof particle board also has a significantly lower swelling rate of 2% to 3% compared to a swelling rate of 28% for a standard particle board, which is classified as P2 according to DIN EN 312:2010. Such standard particle boards P2 are used as furniture boards, for example. The swelling was measured in accordance with DIN EN 317

The edge swelling, which is measured here on the coated board in accordance with DIN EN 13329, cannot be measured on a standard particle board with an adhesive content of less than 12% by weight/atro particle board; it is too high. In contrast, the edge swelling of the waterproof particle board used according to the invention with an adhesive content of more than 12% by weight/atro particle board is only 3% to 4%. Waterproof particle boards of various dimensions are used. In the following exemplary embodiments, the upper face and optionally the lower face are generally provided with a coating, optionally also an edge of a waterproof particle board.

Insofar as adhesive is used in connection with the coating of the waterproof particle board, this adhesive is also referred to as “synthetic resin”, in particular in connection with the exemplary embodiments.

### Exemplary Embodiment 1

Carrier Board Pressed with Paper Laminate

A decor paper 2 and an overlay 3 on top of that are placed on the upper face 1a of a waterproof particle board 1 (format: (length×width×thickness) 2800×2070×22 mm) as shown in FIG. 1. An optionally used backing 4 is optionally placed under the lower face 1b of the particle board 1 and this stack of material to be pressed consisting of three or four layers is pressed in a short-cycle press. Overlay 3, decor paper 1 and the optionally used backing 4 are each used as synthetic resin-impregnated papers, which are described in more detail below. The result is a coated waterproof particle board 1 that has a higher impact resistance than a standard particle board P2 with the same coating, such as is used as a furniture board. The waterproof particle board coated according to this exemplary embodiment can be used in areas subject to high mechanical stress (horizontal applications). An impact resistance test in accordance with DIN EN 14323-07/2017, section 5.13 with the big ball resulted in a value of 1600 mm. A test of a standard particle board P2 with the same coating resulted in a value of 1200 mm. Both boards, both the waterproof particle board used according to the invention and the standard particle board P2, achieved class 4 (>350 revolutions) in terms of abrasion resistance, measured according to DIN EN 14322—as of February 2022.

For exemplary embodiment 1, a decor paper is used, i.e. a resin-impregnated paper with a total weight of 110 to 200 g/m², having
a decorative base paper with a weight of 50 to 90 g/m², with
impregnation with synthetic resin before or after printing, here e.g. based on urea resin or melamine resin or a mixture of the two resins, wherein the synthetic resin is applied in liquid or solid form, in particular in powder form. The synthetic resin is then dried but not yet cured. The synthetic resin has therefore not yet chemically reacted or polymerized to the end. However, it is no longer sticky after drying. The synthetic resin is used in a quantity of 60 g/m² to 110 g/m². The total weight of the resin-impregnated paper is calculated here and in the other data in this description from the weight of the paper and the weight of the resin used, measured after drying and before the resin has cured.

Furthermore, an overlay, also a resin-impregnated paper, with a total weight of 120 to 400 g/m² is used, based on
a base paper with a weight of 25 g/m² to 50 g/m²
an impregnation with synthetic resin based on melamine resin, which is applied aqueously or as a solid, in particular in powder form, and that after drying has a weight of 85 g/m² to 320 g/m².

Finally, an optional backing is used as a synthetic resin-impregnated paper with a total weight of 150 g/m² to 240 g/m², based on
a base paper with a weight of 70 g/m² to 120 g/m²
an impregnation with synthetic resin, here e.g. based on urea resin and/or melamine resin or mixtures of the two resins, which is applied aqueously or as a solid, in particular in powder form. The synthetic resin is applied in a quantity of 80 g/m² to 120 g/m², measured after drying but before curing.

The paper is impregnated with synthetic resin by either passing the paper through an impregnation bath containing liquid synthetic resin, whereby the paper is impregnated with the synthetic resin or synthetic resin mixture and excess synthetic resin is removed, e.g. wiped off, after passing through the bath. The impregnated paper is then dried, taking care to ensure that the synthetic resin does not finally react, i.e. cure. Impregnates usually have a residual moisture (VC=volatile compounds) of VC 5% to 6% after drying. Alternatively or optionally following impregnation of the paper with liquid synthetic resin, powdered synthetic resin is applied to the paper, usually scattered. Insofar as paper impregnated with synthetic resin is mentioned in connection with the present invention, this refers to paper that has been impregnated with synthetic resin, for example as described above.

The further manufacturing of the coating on the waterproof particle board 1 is carried out by manufacturing a stack of material to be pressed, which—from top to bottom—comprises the overlay 3 as synthetic resin-impregnated paper, the decor paper 2 as synthetic resin-impregnated paper, the waterproof particle board 1 and optionally the backing 4 as synthetic resin-impregnated paper. The stack of material to be pressed is then pressed in a short-cycle hot press to form a laminate, whereby the short-cycle press has an upper press plate that acts on the overlay 3, and whereby
under the effect of increased pressure of at least 25 kg/cm² and increased temperature of e.g. 200° C.
and a pressing time of 6 seconds to 30 seconds
manufacturing a laminate optionally with a surface structure that is optionally adapted to the decor (so-called “embossed in register”).

The stack of material to be pressed is heated in the press to such an extent that the synthetic resin first liquefies and then chemically hardens, solidifying as it cools after the press. In exemplary embodiment 1, the structure is embossed into the liquefying synthetic resin and fixed by the hardening of the synthetic resin. Embossing the surface is typical when using synthetic resin-impregnated papers, lacquer, veneer or films, in particular metal or plastic films.

Further optionally, after pressing, a single or multi-layered lacquer coating can be applied to the overlay 3, in particular to adjust surface properties such as gloss, high gloss or mattness of the surface or to create anti-fingerprint properties. The lacquer is preferably applied as a UV lacquer, e.g. as an acrylic lacquer or as a urethane lacquer, typically as a UV or radiation-curing lacquer, usually in two to three layers, whereby preferably in the case of multi-layered lacquer application, the already applied layer is gelled after the application of each lacquer layer. After applying the last layer of lacquer, the lacquer layers are carried out to cure completely. The adhesion of the lacquer layer to the overlay 3 can optionally be improved by applying a primer to the overlay 3 before the lacquer is applied.

Exemplary embodiment 1 thus describes a waterproof particle board 1 to which a two-layer coating, each consisting of a layer of synthetic resin-impregnated paper, is applied to the upper face 1a of the particle board 1. A synthetic resin-impregnated paper can optionally also be applied to the lower face 1b. According to a further variant of this exemplary embodiment, one or more layers of lacquer can be applied to the upper face a on the synthetic resin-impregnated paper, optionally after application of a primer which improves the adhesion of the lacquer to the synthetic resin-impregnated paper.

The surface coating improves the usability of the waterproof particle board 1. The coating creates a smooth and highly resistant surface, apart from an optionally applied structure. This makes the surface of the upper face 1a easier to maintain and better protected against external influences. In addition, edge swelling is minimal.

### Exemplary Embodiment 2

Carrier Board Pressed with Paper Laminate

A decorative paper 2 and an overlay 2 are placed on both sides of waterproof particle board 1 (format: 2800×2070×25 mm) on the upper face 1a and lower face 1b as shown in FIG. 2, and this stack of material to be pressed consisting of five layers is pressed in a short-cycle press. Overlay 3 and decor paper 2 are each used as papers impregnated with synthetic resin. The result is a coated waterproof particle board 1 that has a higher impact resistance and lower swelling than a similar structure with a standard particle board P2. The waterproof particle board 1 produced according to the invention and coated on both sides can be used in areas subject to high mechanical and hygric stress (vertical applications). This may involve, for example, the construction of bathroom or kitchen furniture or the finishing of kitchens, toilet facilities and changing rooms in damp areas or the interior finishing of ships, especially if the waterproof particle board also has a flame-retardant finish. An impact resistance test in accordance with DIN EN 14323-07/2017, section 5.13 with the big ball resulted in a value of 1600 mm. A test of a standard particle board P2 with the same coating resulted in a value of 1200 mm. Both boards achieved class 4 (>350 revolutions) in terms of abrasion resistance

For exemplary embodiment 2, an upper and a lower decorative paper 2 are used as synthetic resin-impregnated paper with a total weight of 110 to 200 g/m², based on
a decorative base paper with a weight of 50 to 90 g/m², with
an impregnation with synthetic resin, e.g. based on urea resin or melamine resin or a mixture of the two resins, carried out before or after printing, whereby the synthetic resin is applied in liquid or solid form, in particular in powder form. The synthetic resin is then dried, but not yet cured, until it has a weight of 60 g/m² to 110 g/m².

Furthermore, an upper and a lower overlay 3 are each used as synthetic resin-impregnated paper with a total weight of 120 to 400 g/m², based on
a base paper with a weight of 25 g/m² to 50 g/m²
an impregnation with synthetic resin, e.g. based on melamine resin, which is applied aqueously or as a solid, in particular in powder form, and which after drying has a weight of 85 g/m² to 320 g/m².

The further manufacturing of the coating on the waterproof particle board 1 is carried out by manufacturing a stack of material to be pressed, which comprises the upper overlay 3 as synthetic resin-impregnated paper, the upper decorative paper 2 as synthetic resin-impregnated paper and the waterproof particle board 1 as well as the lower decorative paper 2 and the lower overlay 3 from above and below. The stack of material to be pressed consisting of five layers is pressed in a short-cycle hot press to form a laminate, whereby the short-cycle press has an upper press plate that acts on the upper overlay 3, and whereby
under the effect of increased pressure of at least 25 kg/cm² and increased temperature of e.g. 200° C.
and a pressing time of 6 seconds to 30 seconds
a laminate is manufactured, optionally with the formation of a surface structure that is optionally adapted to the decor (so-called “embossed in register”).

The waterproof particle board 1 produced in this way, coated on both sides, can be used in particular in vertical applications, e.g. room dividers or cupboard walls. It has particular strength and—in contrast to standard particle boards P2—it can be used in damp and wet rooms or in climatically difficult conditions, e.g. areas with high humidity such as bathrooms or saunas, laundries or car washes.

### Exemplary Embodiment 3

### Lamination of CPL/HPL

A waterproof particle board 1 (format: 2800×600×28/38 mm) with a milled profile 5 on one edge, here embodimented as a curve towards the lower face 1b is coated as shown in FIG. 3. Such a particle board 1 is also known as a strand and is used, for example, as a worktop in kitchens, workshops or laboratories.

A thin laminate (continuous pressure laminate CPL or high pressure laminate HPL) with a thickness of e.g. 0.5 mm is glued to the upper face 1a and a backing 4 is glued to the lower face 1b using an adhesive 6, e.g. a hot melt in this case. The thin laminate 7 consists of an overlay, a decorative paper and several underlay papers arranged under the decorative paper. The decor paper and the overlay are each impregnated with melamine resin. The underlay papers are either impregnated with a melamine/phenolic mixed resin (when CPL is used) or with a phenolic resin (when HPL is used). These thin laminates 7 were manufactured either on a continuous press (CPL) or a multi-daylight press (HPL). The application quantity of the hot melt is approx. 100 g/m².

Either a thin laminate 7, alternatively a plastic film or a paper is used as the backing 4 on the lower face 1b of the waterproof particle board 1, which is bonded to the particle board 1 with the same amount of adhesive as the thin laminate 7.

The pressing is carried out in a laminating press at approx. 120° C., 300 N/cm² and a pressing time of approx. 1 second, whereby in a first pressing operation the backing 4 and in a second pressing operation the thin laminate 7 respectively is glued onto the lower face 1b and the upper face 1a of the particle board 1 respectively.

After the adhesive has cooled, the thin laminate 7 applied to the upper face 1a of the particle board 1 is fixed to the milled edge by applying a PVAc adhesive to the profiled edge on a postforming device, forming the thin laminate 7 around the milled profile 5 and fixing it to the edge with the help of the PVAc adhesive. In this exemplary embodiment, the upper face 1a, lower face 1 b and one edge of the waterproof particle board 1 are thus coated.

An impact resistance test was carried out on this waterproof particle board 1 and a reference sample with a standard particle board P2 coated with a 0.8 mm thick laminate in accordance with DIN EN 438-2019-03, part 2 test 20. The laminate 7 laminated onto the waterproof particle board 1 also achieved an impact resistance value of 22 N despite its significantly lower thickness (0.5 mm vs. 0.8 mm). In addition, the surface stability in the postforming area of the waterproof particle board 1 was also significantly better due to the higher raw density. Furthermore, a thinner laminate can apparently also be used to achieve narrower postforming radii. This considerably expands the design options and, accordingly, the possible uses of a waterproof particle board 1 coated by means of lamination compared to a standard particle board P2 coated in the same way.

### Exemplary Embodiment 4

Carrier Board Floor Pressed with Paper Laminate

A decor paper 2 and an overlay 3 (e.g. an overlay for use class 34 according to DIN EN 13329) are placed on the upper face 1a of a waterproof particle board 1 (format: 2800×2070×10 mm); an optionally used backing 4 is placed under the lower face 1a of the particle board 1. The structure corresponds to the schematic diagram in FIG. 1. This stack of material to be pressed, consisting of four layers, is pressed in a short-cycle press. Overlay 3, decor paper 2 and the optionally used backing 4 are each used as synthetic resin-impregnated papers.

The result is a coated waterproof particle board 1 that has a higher impact resistance than a similar structure with a standard particle board P2 with the same coating. An impact resistance test according to DIN EN 14323-07/2017, section 5.13 with the big ball resulted in a value of 1800 mm. A test of a standard particle board P2 with the same coating resulted in a value of 1200 mm. Both boards achieved use class 34 in terms of abrasion resistance (DIN EN 13329: Laminate flooring-Elements with a surface layer based on aminoplastic heat curable resins, 08-2016)

For exemplary embodiment 4, a decor paper 2 is used as a synthetic resin-impregnated paper with a total weight of 110 to 200 g/m², based on
a decorative base paper with a weight of 50 to 90 g/m², with
impregnation with synthetic resin, e.g. based on urea resin or melamine resin or a mixture of the two resins, carried out before or after printing, whereby the synthetic resin is applied in liquid or solid form, in particular in powder form. The synthetic resin is then dried, but not yet cured, until it has a weight of 60 g/m² to 110 g/m².

Furthermore, an overlay 3 is used as a synthetic resin-impregnated paper with a total weight of 120 to 400 g/m², based on
a base paper with a weight of 25 g/m² to 50 g/m²
an impregnation with synthetic resin, e.g. based on melamine resin, which is applied aqueously or as a solid, in particular in powder form, and which after drying has a weight of 85 g/m² to 320 g/m², and
optionally with a corundum content of approx. 30 g/m², which was introduced either by adding it to the synthetic resin used for impregnation or by scattering it onto the synthetic resin applied to the paper during or after the impregnation process. Corundum must be used if use class 34 is to be achieved.

Finally, an optional backing 4 is used as a synthetic resin-impregnated paper with a total weight of 150 g/m² to 240 g/m², based on
a base paper with a weight of 70 g/m² to 120 g/m²
an impregnation with synthetic resin, e.g. based on urea resin and/or melamine resin or mixtures of the two resins, which is applied aqueously or as a solid, in particular in powder form and then, optionally after drying, has a weight of 80 to 120 g/m².

Further manufacturing of the coating on the waterproof particle board 1 is carried out by manufacturing a stack of material to be pressed, which from top to bottom has the overlay 3 as synthetic resin-impregnated paper, optionally with the addition of corundum, the decor paper 2 as synthetic resin-impregnated paper, the waterproof particle board 1 and optionally the backing 4 as synthetic resin-impregnated paper. The stack of material to be pressed is pressed in a short-cycle hot press to form a laminate, wherein the short-cycle press has an upper press plate that acts on the overlay, and wherein
under the effect of increased pressure of at least 25 kg/cm² and increased temperature, e.g. 200° C.
and a pressing time of 6 seconds to 30 seconds
a laminate is manufactured, optionally with the formation of a surface structure that is optionally adapted to the decor (so-called “embossed in register”).

Optionally, a single- or multi-layered lacquer layer can be applied to the overlay 3, in which optionally a structure is embossed, in particular to adjust surface properties such as gloss, high gloss or mattness of the surface or to create anti-fingerprint properties. The lacquer is preferably applied as a UV lacquer or radiation-curing lacquer, e.g. as a lacquer based on acrylates and/or methacrylates, usually in two to three layers, whereby preferably in the case of multi-layered lacquer application, the already applied layer is gelled after the application of each lacquer layer. After applying the last layer of lacquer, the lacquer layers are carried out to cure completely. The adhesion of the lacquer layer to the overlay can optionally be improved by applying a primer to the overlay before the lacquer is applied.

After coating, smaller panels, so-called raw fixed dimensions, are generated from the waterproof particle board 1 using a multirip saw, which are then provided with a profile at the edges that can be joined without glue, so that the panels can be used as flooring elements or as wall or ceiling elements. Compared to a standard particle board P2, the laminate flooring manufactured according to this exemplary embodiment using the waterproof particle board 1 shows a significantly better milling pattern.

The floor panels manufactured in this way from the coated waterproof particle board 1 can also be used in damp environments due to the dimensional stability resulting from the largely reduced swelling behavior—in contrast to those manufactured from standard particle board P2.

### Exemplary Embodiment 5

Carrier Board with Liquid Overlay Including Direct Decor Printing

Using a thin waterproof particle board 1 (format: 2800×2070×10 mm), a floor panel with a liquid synthetic resin coating is produced (DIN EN 15668: Laminate flooring—Directly printed elements with synthetic resin surface layer, 11-2021). The waterproof particle board 1 is coated with liquid synthetic resin, whereby a base coat is first applied to the particle board and a decor is then applied to this base coat using direct printing. The direct print is then coated with at least two liquid layers of synthetic resin, whereby corundum is optionally introduced into a non-external layer of synthetic resin, e.g. by scattering or jetting. The corundum can also be mixed into the liquid synthetic resin.

The waterproof particle board 1 coated in this way is cured in a short-cycle press (KT press). In detail, the coating of exemplary embodiment 5 is applied as follows:
Applying base coat to the upper face of the waterproof particle board using a synthetic resin applied in liquid form as a primer, e.g. a melamine resin, a urea resin or a mixture of the two synthetic resins in a quantity of approx. 20 g/m² to 30 g/m² (solids content: melamine resin: approx. 65% by weight, urea resin: approx. 50% by weight). Application is carried out using rollers.
Drying the resin using a drying device, e.g. a circulating air dryer or IR radiators, to a moisture content of the base coat of approx. 20%.
Optional: Multiple application of color base coat (e.g. mixture of pigments and binders such as casein or corn protein) in liquid form in a quantity of 5 g/m² to 10 g/m² (solids content: approx. 50% by weight) with intermediate drying by a drying device, e.g. by circulating air or IR emitters. It is usual to apply two to six layers of the color base coat. The application of the color base coat is also carried out by roller application. The use of white pigments (titanium dioxide, calcium carbonate, barium sulphate) is preferred.
Optional: Application of a liquid primer, e.g. an isocyanate primer in a quantity of approx. 10 g/m² to 20 g/m² to improve the adhesion of the subsequent layers to be applied. The primer is dried using a circulating air dryer or IR radiator. Again, a roller application is used.
Printing on the upper face of the waterproof particle board, optionally improved in its adhesion by the primer, either analog, e.g. using a roller, or digital, e.g. using an inkjet printer with water-based inks, then, if necessary, drying the ink using a drying device, e.g. a circulating air dryer.
Application of a sealant by roller application, the liquid sealant consisting of a synthetic resin, preferably melamine resin (solids content approx. 65% by weight) and optionally glass beads mixed therein (diameter of glass beads: 70 μm to 90 μm). The application quantity of the synthetic resin is 20 g/m²-30 g/m² This contains 10% to 20% by weight of glass beads, based on the quantity of liquid synthetic resin. Subsequently, the
Drying, but not curing of the synthetic resin using a circulating air dryer or IR emitter, followed by cooling and intermediate storage.
Application of a liquid synthetic resin, e.g. a melamine resin, by roller application in a quantity of approx. 60 g/m² to 80 g/m² (solids content approx. 65% by weight) to the printed side of the board that has already been sealed with a layer of synthetic resin.
Optional: Scattering corundum onto the undried, liquid melamine resin using a scattering device. The corundum has a grain size of F180 to F240 according to the FEPA standard. The quantity is usually between 20 g/m² and 50 g/m² corundum, depending on the desired wear resistance.
Multiple application (preferably up to 5 layers) of a synthetic resin, e.g. melamine resin, to the upper face of the board in an amount of 20 g/m² to 40 g/m², the melamine resin having the solids content indicated above. When applying the last layers, glass beads (diameter: 70 to 90 μm) are optionally added to the synthetic resin, again in an amount of 10 wt. % to 20 wt. % based on the amount of liquid synthetic resin. After each application, intermediate drying is carried out with a drying device, e.g. with the help of circulating air dryers or IR radiators.
In addition to the coatings on the upper face, a liquid synthetic resin, e.g. a melamine resin, can optionally be applied to the backside of the particle board. This can also be carried out with a roller applicator and the application of the liquid synthetic resin can, for example, reach a total quantity of 100 g/m² to 140 g/m². The melamine resin has the usual solids content specified above. The synthetic resin may also contain colorant or pigment. Here too, intermediate drying must be carried out, either by means of a circulating air dryer or an IR lamp.
Finally, the waterproof particle board coated on one or both sides with the dried but not yet cured coating is pressed in a short-cycle hot press as already described for exemplary embodiment 1 to form a laminate with cured synthetic resin
   under the effect of increased pressure of at least 25 kg/cm² and increased temperature of 200° C.
   and a pressing time of 6 to 30 s
   optionally with the formation of a surface structure above the decor;
   optionally adapted to each other, as so-called “embossed in register.”

The impact resistance (big ball) determined on the coated waterproof particle board of this exemplary embodiment was 1400 mm. A test on a comparable product with a standard particle board P2 only resulted in an impact resistance of 900 mm. This means that the product with the waterproof particle board achieves use class 33, whereas the comparative product with the standard particle board P2 only achieves use class 32.

If further processing of the coated waterproof particle board is desired, e.g. to form a panel with a profiled edge, this can be carried out in exactly the same way as described in exemplary embodiment 4. The use of the coated waterproof particle board or a panel made of the coated particle board can also be carried out in the same way. The properties of the carrier board coated according to exemplary embodiment 5 are comparable to those of the coated particle board according to exemplary embodiment 1.

### Exemplary Embodiment 6

Carrier Board Floor Pressed with Paper Laminate (Elastic Laminate)

A decorative paper 2 and an overlay 2 are placed on the upper face 1a of a waterproof particle board 1 (format: 2800×2070×10 mm); an optionally used backing 4 is placed under the lower face 1b of the particle board 1 and this stack of material to be pressed, consisting of three or four layers, is pressed in a short-cycle press. Overlay 3, decor paper 2 and the optionally used backing 4 are each used as synthetic resin-impregnated papers. The synthetic resins used are polyurethane dispersions, in this case either PUR CHEM WB-420 or, as a softer-touch variant, PUR CHEM LC-380, each with the crosslinker PUR-CHEM AD-200R and optionally a release agent such as WB-475; all the aforementioned products are from the manufacturer PurChem Systems Inc. The result is a coated, waterproof particle board 1 that has a higher impact resistance than a similar structure with a standard particle board P2.

A test of impact resistance according to DIN EN 14354:2017-11, Annex C, explains that a test object that has a resistance to impact stress (elasticity) of more than 1400 mm thus achieves EC3 level. DIN EN 14323-07/2017, section 5.13 with the big ball resulted in a value of 1500 mm for the waterproof particle board 1 according to the invention. A test of a standard particle board P2 with the same coating resulted in a value of 1200 mm.

For exemplary embodiment 6, a decor paper is used as a synthetic resin-impregnated paper with a total weight of 110 to 200 g/m², based on
a decorative base paper with a weight of 50 to 90 g/m², with
impregnation with synthetic resin based on the polyurethane dispersion described above (solids content: approx. 50% by weight), carried out before or after printing. The synthetic resin is then dried, but not yet cured, until it has a weight of 60 g/m² to 110 g/m².

Furthermore, an overlay is used as a synthetic resin-impregnated paper with a total weight of 103 to 400 g/m², based on
a base paper with a weight of 18 g/m² to 50 g/m²
an impregnation with synthetic resin based on the PU dispersion described above (solids content: approx. 55% by weight), and that after drying but before curing a weight of 85 g/m² to 320 g/m² is present, and optionally a corundum content of approx. 30 g/m², was introduced by addition to the dispersion or by scattering during or after impregnation of the base paper. Alternatively, corundum can already be contained in the base paper.

Finally, an optional backing is used as a synthetic resin-impregnated paper with a total weight of 80 g/m² to 240 g/m², based on
a base paper with a weight of 70 g/m² to 120 g/m²
an impregnation with synthetic resin based on the PU dispersion described above (solids content: approx. 55% by weight), which is applied in liquid form and which, after drying but before hardening, has a weight of 80 g/m² to 120 g/m².

The further manufacturing of the coating on the workpiece is carried out by manufacturing a stack of material to be pressed, which has, from top to bottom, the overlay as synthetic resin-impregnated paper, the decorative paper as synthetic resin-impregnated paper, the waterproof particle board and optionally the backing as synthetic resin-impregnated paper. The stack of material to be pressed is pressed in a short-cycle hot press to form a laminate, whereby the short-cycle press has an upper press plate that acts on the overlay, and whereby
under the effect of increased pressure of at least 25 kg/cm² and increased temperature of e.g. 200° C.
and a pressing time of 6 seconds to 30 seconds and
a laminate is manufactured, optionally with the formation of a surface structure that is optionally adapted to the decor (so-called “embossed in register”).

Optionally, one or more layers of lacquer can be applied to the overlay in which a structure is embossed, as described for exemplary embodiment 1.

This embodiment of the coated, waterproof particle board also has very low edge swelling, although here too the board shrinks back to its original thickness after drying. After the coating has been applied, smaller panels, known as raw fixed dimensions, are generated from the waterproof particle board on a multirip saw, which can then be further processed into flooring elements with a glueless profile. Compared to a standard particle board P2, the laminate flooring manufactured with the waterproof particle board has a significantly better milling pattern.

### Exemplary Embodiment 7

Waterproof Particle Board with Veneer Surface:

The base materials are explained below. As an alternative to the paper backing (alternative I), a veneer backing (alternative II) can also be used. The veneer for the backing can be of the same or different, in particular simpler, quality as the veneer for the upper face.

### Veneer for the Upper Face:

Thickness: 0.6 mm
Type: Oak

### Paper: Synthetic Resin Impregnated Kraft Paper

Paper weight: 25 g/m²
Resin application: 600%
Synthetic resin: Melamine resin
   waterproof particle board: Thickness 7.8 mm

### Backing:

| I Paper: | Synthetic resin impregnated kraft paper | |
|---|---|---|
| | Paper weight: 25 g/m² | |
| | Resin application: | 600% |
| | Synthetic resin: | Melamin resin |
| II Veneer | Thickness | 0.6 mm |
| | Type: | Poplar |

The above specifications are exemplary and can be varied, e.g. depending on the veneer used, e.g. the veneer thickness, the veneer moisture content or the density of the veneer or the wood type of the veneer.

### Manufacturing of the Resin-Impregnated Paper

The paper is passed through a bath of liquid synthetic resin, in this case melamine resin. In the bath, the paper is impregnated or soaked with liquid synthetic resin. After impregnation or soaking, excess synthetic resin is removed by a scraper so that there is only a layer of synthetic resin on the upper face of the now resin-impregnated paper. The upper face of the resin-impregnated paper is made of synthetic resin, in this case: melamine resin. The amount of synthetic resin used can be varied. However, it is preferably measured in such a way that the applied veneer penetrates at least ⅔ of the veneer thickness during subsequent pressing by the synthetic resin liquefied in the press. It is further preferred that the veneer is compressed in the press. According to a particularly preferred embodiment, the veneer is thus impregnated with synthetic resin to at least ⅔, preferably completely, after completion of the pressing process. Swelling and shrinkage of the veneer is thus largely reduced.

The paper soaked in this way is dried to a residual moisture of 5% to 6%, for example. The resin application of the 25 g/m² paper was 600% based on the weight of the paper. Drying is carried out, for example, in a channel dryer in which hot air nozzles flow onto the paper from the upper face and the lower face, thereby drying it, but the synthetic resin is not cured. The dried, resin-impregnated paper can now be stored until it is used.

The resin-impregnated paper for the backing can be manufactured in the same way as described above. The resin-impregnated paper for the backing is also dried to a VC value of e.g. 6%. The veneer for the backing can be prepared and subsequently processed in the same way as the veneer for the upper face.

### Manufacturing the Veneered Board

The backing, carrier board, resin-impregnated paper and veneer are layered to form a stack of material to be pressed, with the upper face of the resin-impregnated paper, which has resin, facing the upper face of the waterproof particle board and the lower face facing the veneer. The stack of material to be pressed is placed in a KT press (short-cycle press) and pressed there at a temperature of 180° C. and a pressure of p=30 N/mm² for a pressing time of 60 seconds.

It can be pressed with a simple, smooth press plate. In this exemplary embodiment, however, structured press plates serving as structuring means can also be used as an alternative. For example, a press plate with a wood structure can be used. The wood structure of the press plate is then recognizable in the veneer, which may differ from the wood structure of the veneer. No recognizable melamine resin layer had been configured on the upper face of the veneer. The coated waterproof particle board was then optionally finished with a UV lacquer with an application quantity of 50 g/m² to 100 g/m² or with a UV oil with an application quantity of 20 g/m² to 40 g/m² on the surface. The application quantities are based on the desired use class. Corundum can optionally be incorporated into the UV lacquer, especially if higher use classes with improved abrasion resistance are to be achieved.

The veneer surface on the upper face is thus accentuated or designed in a way that was previously not possible. The backside of the waterproof particle board can be left as it is, especially if a veneer has been applied in accordance with alternative II, or alternatively, impact sound insulation can be laminated on afterwards, for example.

The method according to the invention offers a better design option and thus usage properties of a veneered board.

### Exemplary Embodiment 8

Coating with Hotmelt

Another alternative for coating the surface of the particle board according to the invention is to apply a hot melt, e.g. a polyurethane hot melt (PU hot melt), a polyester, polyamide, polyolefin or polyacetate hot melt, e.g. ethyl vinyl acetate hot melt. In general, thermoplastics, especially post-crosslinking thermoplastics, can be used as hot melts. Hot melts can be applied in a single or multi-layered form, with multi-layered application being preferred. Hot melts can have the same aggregates as described above for the application of plastic. Hotmelts can be used unpigmented or pigmented, whereby the proportion of pigments can be up to 30% by weight. Hotmelts can be transparent or opaque. A hot melt can be applied over the entire surface or in sections to the surface of the workpiece according to the invention. A hot melt is applied in an amount of 10 g/m² to 300 g/m², preferably in an amount of 50 g/m² to 200 g/m². A hotmelt is fixed by cooling after the hotmelt is applied at a temperature of 80° C. to 160° C., usually from 100° C. to 130° C. A hotmelt can be rolled on, squeegeed on or sprayed on. An already applied and preferably already cooled layer of hotmelt can be printed, in particular with water-based or UV-drying ink. A hotmelt coating is also often combined with a layer of lacquer, usually with a final, outer layer of lacquer that forms the outer face of the coated board-shaped workpiece. A hotmelt is also frequently used to fix other coating materials, especially in combination with laminated materials such as continuous pressure laminate (CPL) or high pressure laminate (HPL). In this case, however, the hotmelt is not a surface coating, but an adhesive for other coating materials.

In concrete terms, such a coating can be implemented as follows, for example:
Application of a white-pigmented polyurethane hotmelt (PU hotmelt) to the carrier board
(application quantity: approx. 60 g/m² to 120 g/m²), which is applied in liquid form at a temperature of 120° C. using a roller applicator to the surface or upper face of the carrier board, which serves as the workpiece here, and, if necessary, smoothing of the still liquid hot melt in a second applicator. The proportion of pigment in the PU formulation is approx. 20% by weight.
Cooling the surface
Printing a white, liquid ink layer with a digital printer (application quantity: 10 g/m² to 20 g/m², optionally followed by drying the ink layer, e.g. using an air circulating dryer.
Printing the surface using a digital printer with a decor using water-based or UV inks, optionally followed by drying the ink, e.g. using an air circulating dryer.
Application of a further, non-pigmented PU hotmelt layer (application quantity: 50 g/m²) using a roller application unit.
Scattering of corundum particles into the hotmelt (grain size: F180 to F240 according to FEPA standard) with the aid of a scattering apparatus (application quantity: between 10 g/m² and 50 g/m², depending on the desired abrasion resistance).
Application of a further PU layer (application quantity: approx. 30 g/m²) with a roller application unit.
Cooling the surface
Lacquering the surface with a UV lacquer containing approx. 30 g/m² corundum nanoparticles to improve scratch resistance (lacquer application quantity: 10 g/m² to 40 g/m²) with subsequent UV curing.

This coated particle board can also be cut into panels as described for exemplary embodiment 1 and provided with edge profiles. The use of the particle board coated in accordance with exemplary embodiment 3 and optionally the panels produced therefrom is also as described in exemplary embodiment 1.

### LIST OF REFERENCE SYMBOLS

1 waterproof particle board
1a Upper face
1b Lower face
2 Decor paper
3 Overlay
4 Backing
5 Profile
6 Adhesive
7 Thin laminate

1. Method for coating a waterproof particle board, wherein the particle board contains chips of wood with a length of 0.5 mm to 50 mm, with a width of 0.1 mm to 20 mm and with a thickness of 0.05 mm to 2 mm and has at least one adhesive with an adhesive content of at least 17% by weight/atro of wood, comprising the steps:
providing the particle board, which has an upper face and a lower face and lateral surfaces,
applying a coating, and
applying a decor.

2. Method according to claim 1, wherein the coating is selected from the group consisting of heat curable synthetic resins, lacquers, and combinations thereof.

3. Method according to claim 1, wherein the coating is applied as a liquid coating, as a particulate coating, in the form of paper and/or in the form of a film, a veneer, a laminate and/or a felt.

4. Method according to claim 1, wherein the coating is single- or multi-layered.

5. Method according to claim 1, wherein the coating is cured under the action of pressure and/or temperature.

6. Method according to claim 1, wherein the coating is cured by radiation.

7. Method according to claim 1, wherein the coating is fixed to the waterproof particle board by adhesive.

8. Method according to claim 1, wherein the structuring is generated by mechanical or chemical means.

9. Method according to claim 1, wherein the coating is provided with aggregates.

10. A particle board manufactured from a material comprising lignocellulosic chips with a length of 0.5 mm to 50 mm, with a width of 0.1 mm to 20 mm and with a thickness of 0.05 mm to 2 mm and more than 17% by weight of adhesive, wherein the board-shaped workpiece has an upper face, a lower face and lateral surfaces, wherein the upper face, lower face or at least one lateral surface are provided at least in sections with a coating which has a decor.

11. The particle board according to claim 10, wherein a primer is applied between the workpiece and the coating or onto a coating.

12. The particle board according to claim 10, wherein an adhesive is applied between the workpiece and the coating.

13. A particle board according to claim 10, wherein at least two opposing lateral surfaces have a profile.

14. A covering for a floor, wall or ceiling, comprising the particle board according to claim 10.

15. Method according to claim 1, further comprising structuring the coating on at least a section of the upper face, the lower face or the lateral surface.

16. Method according to claim 15, further comprising curing the coating.

17. Method according to claim 1, further comprising curing the coating.

18. Method according to claim 6, wherein the radiation is electron-curing radiation or UV radiation.

19. Method according to claim 9, wherein the aggregates are corundum or glass beads.

20. The particle board according to claim 10, wherein the coating has a structure.
